(19) United States
(12) Patent Application Publication
(10) Pub. No.: US 2008/0157622 A1
(43) Pub. Date: Jul. 3, 2008

(54) Fault-tolerant permanent magnet machine

(75) Inventors: Manoj Ramprasad Shah, Latham, NY (US); Ayman Mohamed Fawzi El-Refaie, Niskayuna, NY (US)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 11/649,395

(22) Filed: Jan. 3, 2007

(51) Int. Cl. H02K 47/00; H02K 1/00; H02K 23/02

(52) U.S. Cl. 310/184; 310/180; 310/113

(57) ABSTRACT

A system is provided in a permanent magnet (PM) machine comprises a stator, a rotor configured to rotate relative to the stator, a first set of windings disposed within the stator; and a second set of windings wound back and forth toroidally around the circumference of the stator. In accordance with an embodiment of the present technique the set of windings is configured to generate a magnetic flux saturating the stator so as to limit fault currents within the PM machine.

### BACKGROUND

The invention relates generally to permanent magnet (PM) machines, such as electric generators and/or electric motors. Particularly, this invention relates to fault tolerant PM machines.

Many new aircraft systems are designed to accommodate electrical loads that are greater than those on current aircraft systems. The electrical system specifications of commercial airliner designs currently being developed may demand up to twice the electrical power of current commercial airliners. This increased electrical power demand must be derived from mechanical power extracted from the engines that power the aircraft. When operating an aircraft engine at relatively low power levels, e.g., while idly descending from altitude, extracting this additional electrical power from the engine mechanical power may reduce the ability to operate the engine properly.

Traditionally, electrical power is extracted from the high-pressure (HP) engine spool in a gas turbine engine. The relatively high operating speed of the HP engine spool makes it an ideal source of mechanical power to drive the electrical generators connected to the engine. However, it is desirable to draw power from additional sources within the engine, rather than rely solely on the HP engine spool to drive the electrical generators. The LP engine spool provides an alternate source of power transfer, however, the relatively lower speed of the LP engine spool typically requires the use of a gearbox, as slow-speed electrical generators are often larger than similarly rated electrical generators operating at higher speeds.

PM machines (or generators) are a possible means for extracting electric power from the LP spool. However, aviation applications require fault tolerance, and as discussed below, PM machines can experience faults under certain circumstances and existing techniques for fault tolerant PM generators suffer from drawbacks, such as increased size and weight.

As is known to those skilled in the art, electrical generators may utilize permanent magnets (PM) as a primary mechanism to generate magnetic fields of high magnitudes for electrical induction. Such machines, also termed PM machines, are formed from other electrical and mechanical components, such as wiring or windings, shafts, bearings and so forth, enabling the conversion of electrical energy from mechanical energy, where in the case of electrical motors the converse is true. Unlike electromagnets which can be controlled, e.g., turned on and off, by electrical energy, PMs always remain on, that is, magnetic fields produced by the PM persists due to their inherent ferromagnetic properties. Consequently, should an electrical device having a PM experience a fault, it may not be possible to expediently stop the device because of the persistent magnetic field of the PM causing the device to keep operating. Such faults may be in the form of fault currents produced due to defects in the stator windings or mechanical faults arising from defective or worn-out mechanical components disposed within the device. Hence, the inability to control the PM during the above mentioned or other related faults may damage the PM machine and/or devices coupled thereto.

Further, fault-tolerant systems currently used in PM machines substantially increase the size and weight of these devices limiting the scope of applications in which such PM machines can be employed. Moreover, such fault tolerant systems require cumbersome designs of complicated control systems, substantially increasing the cost of the PM machine.

### BRIEF DESCRIPTION

In accordance with an embodiment of the present technique, a method and system are provided in which a stator of a PM machine is wound with a second set of coils in addition to standard stator coils of the PM machine. The second set of coils, also termed as auxiliary toroidal windings, are wound back and forth in a zigzag/spiraling pattern toroidally around the circumference of the stator. Accordingly, the auxiliary toroidal windings are configured to limit fault currents within the PM machine such that these currents are maintained at a tolerable level. Further, the auxiliary toroidal windings of the stator may be coupled to and powered by a main power converter of the PM machine or they may be powered by a separate power converter. The latter configuration provides an additional layer of fault tolerance should the main power converter of the PM machine fail.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical side view of an electrical device, such as a motor or generator, in accordance with an embodiment of the present technique;

FIG. 2 is an end-view of the electrical device shown in FIG. 1 in accordance with an embodiment of the present technique;

FIG. 3 is an angular section of the end-view shown in FIG. 2 in accordance with an embodiment of the present technique;

FIG. 4 is a top view of an electrical device, such as that shown in FIG. 1, in accordance with an embodiment of the present technique; and

FIGS. 5A-5C are diagrammatical views of electrical configurations coupling toroidal windings of a stator to a converter in accordance with embodiments of the present technique.

### DETAILED DESCRIPTION

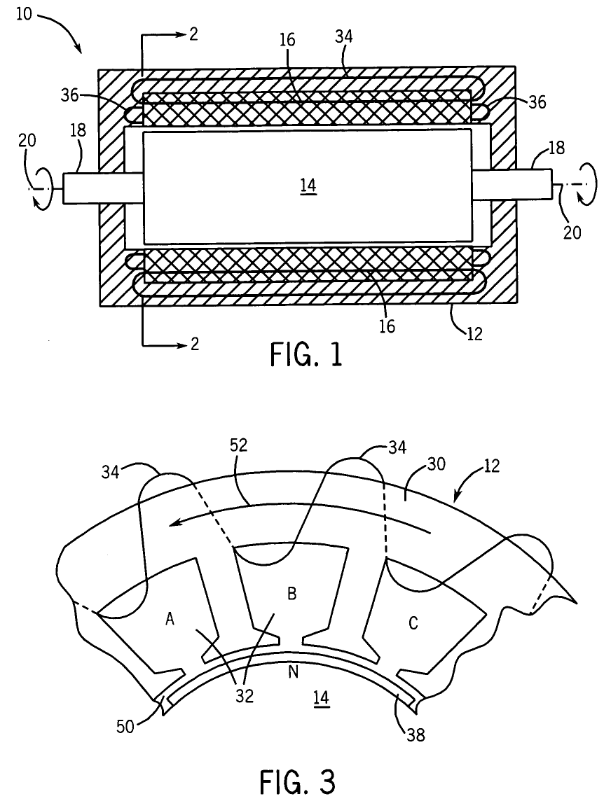

Turning to the figures, FIG. 1 is a diagrammatical side view of an electrical device in accordance with an embodiment of the present technique. The electrical device depicted in FIG. 1 may include a motor, a generator, a motor-generator or other electrical devices employing permanent magnets. For example, the electrical device of FIG. 1 may be an aircraft engine, such as a turbofan engine, having a rotational member coupled to a PM machine for generating supplemental electrical power. In the embodiment illustrated, a PM machine 10 includes a stator 12 and a rotor 14. PM machine 10 may be used in industrial and military applications or it may be applied to any number of modalities, such as commercial and residential applications. Disposed about stator 12 are auxiliary toroidal windings 34 (see also FIG. 2), such that half of their length generally encompasses regions 16 within the stator's inner periphery. Stated otherwise, region 16 is routed with the auxiliary toroidal windings lengthwise between the two opposing ends of stator 12. As will be described further below, the auxiliary toroidal windings of stator 12 are configured to saturate stator 12 of PM machine 10 with magnetic flux so as to limit fault currents.

In the illustrated embodiment, stator 12 forms a protective shell for rotor 14. In an alternative embodiment, an “inside-out” generator architecture may be employed. An “inside out” electrical generator is an electrical generator that includes an outer rotor section that rotates around an inner stator section to generate electric power. The “inside out” arrangement of the generator is the reverse of the conventional electric generator, in which the rotor section rotates inside of the stator section.

Stator 12 may be formed of a single structure or it may be formed of multiple parts, such as multiple laminations stacked and held together, for example, by end caps formed of any number of materials, such as steel, aluminum, or any other suitable structural material. PM machine 10 may also include stator coil windings 36 wound about the circumference of stator 12 housed preferably in stator slots 32 and on the inside of stator yoke or back iron 30 of the PM machine configuration shown in FIG. 2. Such coil windings are configured to, for example, route current induced by rotor 14 when the rotor undergoes rotation. It should be born in mind that such coil windings are not be confused with the above-mentioned auxiliary toroidal windings adapted for fault tolerance purposes.

PM machine 10 further includes a rotary shaft 18 coupled to rotor 14. Accordingly, rotary shaft 18 is rotatable about rotation axis 20 and shaft 18 may be configured for coupling to any number of drive machine elements (not shown), thereby transmitting/receiving torque to or from the given machine element. Rotor 14 and shaft 18 may be supported in stator 12 by front and rear bearing sets carried by, for example, front and rear end-caps.

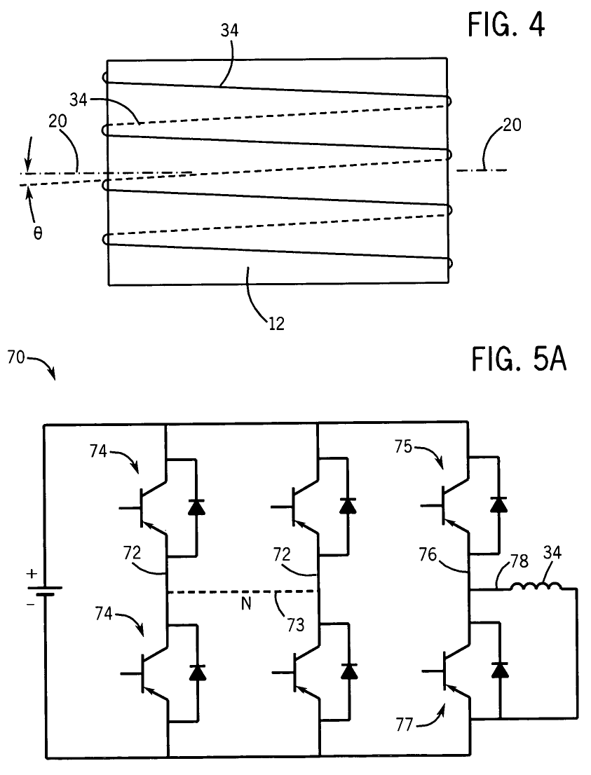

FIG. 2 illustrates an end-view of PM machine 10 along line 2-2 shown in FIG. 1, in accordance with an embodiment of the present technique. In the illustrated embodiment, stator 12 includes stator yoke 30 having multiple axial slots 32 disposed at different angular positions about the circumference of rotor 14, such that slots 32 circumferentially encompass rotor 14. Auxiliary toroidal windings 34 are routed or threaded through slots 32 lengthwise along and about stator 12, such that a wire or a plurality of wires are wound back and forth along and around stator 12 in a zigzag spiraling pattern from one slot 32 to another (FIG. 4). Specifically, a wire may be routed lengthwise along an interior of stator 12 in a first slot from a first end to an opposite second end. The wire then may be routed from the interior to the exterior of stator 12 at the second end, the wire then may be routed lengthwise along the exterior from the second end to the first end, the wire then may be routed into a second slot, and the process repeats for the second slot and each successive slot. As the wire is routed from one slot 32 to another, the wire essentially zigzags as shown in FIG. 4. Thus, when viewed from an end, such as in FIG. 2, windings 34 populate slots 32 such that windings 34 appear to circumferentially wind a torus. While in the illustrated embodiment each of slots 32 is shown as being routed with a single wire, other embodiments of stator 12 may include multiple windings of a wire or a plurality of wires, such as tens, hundreds, or thousands of wires routed in slots 32. It should further be kept in mind that the wire wound about stator 12 forming auxiliary toroidal windings 34 may be formed of a single strand or it may be formed of multiple strands or bundles of wires, such as a litz wire.

As stated above, stator 12 also includes stator coil windings, such as those included for example in a standard motor and/or a generator. In FIG. 2, the stator coil windings of the present embodiment are referenced by reference numeral 36. It should be kept in mind that coil windings 36 and auxiliary toroidal windings 34 form two distinct sets of windings within PM machine 10, both in the manner windings 34 and 36 operate and in the manner windings 34 and 36 are wound about stator 12. Coil windings 36 are electrically interconnected to form groups, which are, in turn, interconnected in a suitable manner. Coil windings 36 are further coupled to terminal leads, which electrically connect coil windings 36 to an external power source or load, via a converter, such as a 480 Vac three phase power or 110 Vac single phase power. In the illustrated embodiment, coil windings 36 are connected to three-phase power, where each of the three phases is labeled in FIG. 2 as “A”, “B” and “C”, respectively. Further, in the embodiment illustrated, PM machine 10 is illustrated as a four-pole machine, meaning rotor 14 includes a four-pole permanent magnet 38. Poles 38 of the PM are disposed about four quadrants of motor 14 in an alternating pattern.

A PM machine 10, such as the one described herein with reference to FIG. 2, may operate as a motor in which case routing of electrical current from an external power source through coil windings 36 produces a magnetic field about the rotor causing it to rotate. Similarly, if PM machine 10 is a generator, then rotation of rotor 14 induces current in coil windings 36, thereby producing, for example, three-phase power. While the present embodiment shows a four-pole PM machine with four groups of coil windings 36 coupled to three-phase power accordingly, other embodiments may include PMs having two, six, etc. poles having coil winding configurations with different phase-power connections. That is, other embodiments of the present technique may include PM machines having different number of phases other than the ones shown in FIG. 2

Depending on PM machine design and specifications, routing windings 36 within stator 12 may be done manually or automatically with the aid of a threading machine. Similarly, auxiliary toroidal windings 34 may be routed about stator 12 before or after coil windings 36 are routed within stator 12. For example, disposing a spacer between stator 12 and coil windings 36 in a manner that sufficiently temporarily separates coil windings 36 and stator 12, it is possible to rout auxiliary toroidal windings 34 about stator 12 after coil windings 36 are routed within stator 12.

Auxiliary toroidal windings 34 are configured to limit fault currents. For example, if during operation of PM machine 10 detrimental defects within coil windings 36 render electrical currents routed therethrough as potentially damaging to PM machine 10, auxiliary toroidal windings 34 may be provided with direct-current (DC) power sufficient to saturate stator 12. As a result, a drop of magnetic flux is achieved throughout stator 12, effectively increasing the reluctance of PM machine 10 and thereby limiting fault currents otherwise not manageable within PM machine 10. Hence, by limiting fault currents, for example, within coil windings 36, damage to coil windings 36 and to other elements of PM machine 10 can be prevented or reduced by powering auxiliary toroidal windings 34. As discussed further below, powering auxiliary toroidal windings 34 may be done by a separate power source, such as a separate converter, or by a main converter to which coil windings 36 of PM machine 10 are connected as well.

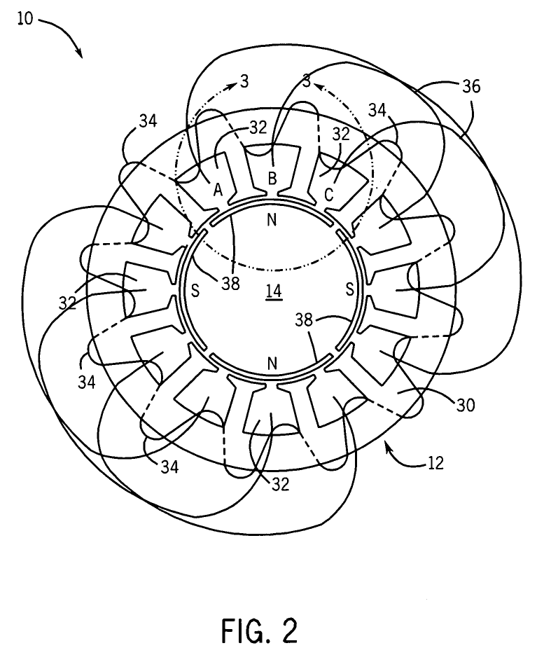

FIG. 3 is an angular section along line 3-3 of the end-view of stator 12 of FIG. 2, in accordance with an embodiment of the present technique. Accordingly, FIG. 3 depicts a closer view of a section of stator 12, and particularly auxiliary toroidal windings 34. In the illustrated embodiment, slots 32 are circumferentially disposed adjacent to each other with a regular pitch. As further depicted, auxiliary toroidal windings 34 are successively threaded in each of slots 32 such that auxiliary toroidal windings 34 curl around each slot as they zigzag in a spiraling pattern back and forth across and around stator 12 (FIG. 4). While the present embodiment illustrates a single wire forming auxiliary toroidal windings 34 per slot 32, alternative embodiments of the present technique may include routing multiple wires (e.g., tens, hundreds or thousands) in each slot 32 to form auxiliary toroidal windings 34.

Disposed inside stator 12 is rotor 14 having a PM 38 disposed thereon. In the illustrated embodiment, only a portion of PM 38 is depicted such that its North pole points towards the slots 32 of stator 12. A gap 50 exists between stator 12 and rotor 14 so that the rotor may be free to rotate within the shell provided by stator 12. The manner by which auxiliary toroidal windings 34 are threaded about stator 12, as shown in FIG. 3, is designed to render PM machine 10 fault tolerant. That is, in situations in which fault currents develop during operation of PM machine 10, auxiliary toroidal windings 34 may be powered to create a magnetic flux throughout the stator yoke or back iron 30, as shown by arrow 52, inducing an overall drop in the fault currents arising in, for example, coil windings 36 (FIG. 2).

FIG. 4 is a top view of a PM machine, such as PM machine 10 depicted in FIG. 1, in accordance with an embodiment of the present technique. FIG. 4 depicts the manner by which auxiliary toroidal windings 34 are wound lengthwise across stator 12. The winding 34 shown with solid lines extend along the exterior of stator 12, while winding 34 shown by dashed lines extend inside stator 12 in each successive slot 32. Accordingly, auxiliary toroidal windings 34 are wound in a zigzag spiraling pattern lengthwise across stator 12 such that windings 34 encompass the circumference of stator 12. Because auxiliary toroidal windings 34 are threaded between adjacent slots 32 (FIG. 3) of stator 12, they form an angle θ with respect to rotation axis 20 when disposed lengthwise across stator 12. While the illustrated embodiment shows a single auxiliary toroidal windings 34 per slot 32 (FIG. 2) of stator 12, other embodiments may include multiple windings per slot such that the length of stator 12 is populated with additional auxiliary toroidal windings, such as windings 34.

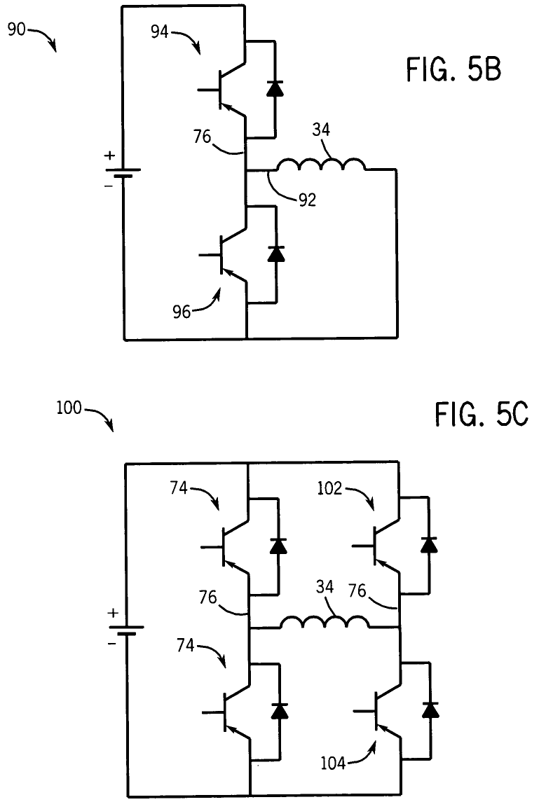

FIGS. 5A-5C are diagrammatical views of electrical configurations coupling toroidal windings 34 of stator 12 to a converter, in accordance with an embodiment of the present technique. Accordingly, FIG. 5A depicts a main power converter 70 generally configured for converting between electrical signals of various wave forms. In the illustrated embodiment, converter 70 includes a plurality of legs 72 connected in parallel to each other. Each of the plurality of legs 72 includes switches 74. Switches 74 may comprise a plurality of solid state devices, such as insulated gate bipolar transistors (IGBTs), diodes, metal-oxide-semiconductor field-effect transistors (MOSFETs) and so forth. In the illustrated embodiment, converter 70 includes N legs, as indicated by line 73 where N generally corresponding to the number of phases of the PM machine. For example, in an embodiment in which a PM machine is coupled to three phase power, such as PM machine 10 of FIG. 1, converter 70 would be formed of three legs, i.e., N=3.

As further shown in FIG. 5A, main converter 70 is augmented by an additional leg 76 formed of switches 75 and 77. Switches 75 and 77 may be devices similar to those described with regard to legs 72 or they may be devices of a different type. The types of switches used may depend on fault-tolerance matching criteria of PM machine 10. For example, switches 75 and 77 may be adapted to sustain low duty cycles whereby high currents are routed through auxiliary toroidal windings 34 for short periods of time as the core of stator 12 is saturated by magnetic flux. Accordingly, leg 76 provides power, via lead 78, to auxiliary toroidal windings 34, such as those described with reference to FIGS. 2-4. Thus, leg 76 would be operable in the event fault currents arise within PM machine 10. The configuration shown in FIG. 5A is advantageous in that it entails augmenting main converter 70 with only one additional leg 76, thus, reducing the overall weight and size of PM machine 10.

FIG. 5B depicts a power converter 90 used for powering auxiliary toroidal windings 34, in accordance with the present technique. Power converter 90 is a single-phase half bridge which can be incorporated into a PM machine as a dedicated device for powering the auxiliary toroidal windings, such as windings 34 (FIGS. 2-4). Accordingly, power converter 90 may be separate from a main power converter used to power the PM machine, e.g., stator coil windings etc., as described with regard to PM machine 10 of FIGS. 1-4.

Hence, converter 90 includes a single leg 76 formed of two devices 94 and 96 formed of the aforementioned solid state devices or other devices. Such devices may sustain low duty cycles whereby high currents are routed through auxiliary toroidal windings 34, saturating the core of stator 12. Powering auxiliary toroidal windings 34 with converter 90 is facilitated by lead 92 which connects leg 76 of converter 90 to windings 34. In having a separate converter powering auxiliary toroidal windings 34, PM machine 10 is provided with an additional layer of system fault-tolerance in case the main power converter of PM machine 10 fails. That is, should the main converter, such as power converter 70 of FIG. 5A, stop functioning when fault currents arise within the PM machine, power converter 90 can be used to independently power auxiliary toroidal windings 34 so as to maintain currents within PM machine 10 at a tolerable level.

FIG. 5C illustrates a power converter 100 used for powering auxiliary toroidal winding 34 in accordance with the present technique. Converter 100 is a single-phase full bridge power converter which can be incorporated into a PM machine, such as PM machine 10 of FIGS. 1-4, as a dedicated device for powering auxiliary toroidal windings 34. Accordingly, converter 100 is formed of two legs 76 connected in parallel such that each leg 76 is formed of two devices 102 and 104. As mentioned above, devices 102 and 104 may comprise a plurality of solid state devices, such as IGBTs, diodes, MOSFETs and so forth or they may be similar to devices 75, 77, 94 and 96. In having two legs, i.e., legs 76, converter 100 is operable to handle signals whose currents and voltages have various polarities. Accordingly, auxiliary toroidal windings 34 are coupled to converter 100 such that the two ends of auxiliary toroidal windings 34 are connected between legs 76. Similar to the configuration shown if FIG. 5B, utilizing converter 100 provides PM machine 10 an additional layer of system fault-tolerance in case the main power of converter of the PM machine fails.

As previously mentioned, PM machine 10 shown in FIG. 1 may be employed in aviation applications, such as in aircraft engines. Particularly, PM machine 10 may be a PM generator used for generating supplemental electrical power from a rotating member, such as a low pressure (LP) turbine spool, of a turbofan engine mounted on an aircraft. Particularly, PM generator 10 includes stator 12 and rotor 14 rotatably mounted relative to stator 12. PM generator further includes a primary set of windings 36 disposed within stator 12, and an auxiliary set of windings 34 wound back and forth toroidally around the circumference of stator 12. Further, PM generator 10 of the above mentioned turbofan engine includes a main power converter, such as power converters 70, 90 and 100 of FIGS. 5A-5C, for converting the electrical power from PM generator 10 to power a load. Accordingly, the turbofan engine is coupled, via shaft 18, to rotor 14 of PM generator 10 for driving PM generator 10. Although this example is directed to electric power extraction for aviation applications, the invention can be used for a variety of applications, non-limiting examples of which include traction applications, wind and gas turbines, starter-generators for aerospace applications, industrial applications and appliances.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a permanent magnet (PM) machine, comprising:
a stator;
a rotor configured to rotate relative to the stator;
a first set of windings disposed within the stator; and
a second set of windings wound back and forth toroidally around the circumference of the stator.

2. The system of claim 1, wherein the second set of windings is wound back and forth in a zigzag pattern toroidally around the circumference of the stator.

3. The system of claim 1, wherein the stator defines a plurality of axial slots, and wherein the second set of windings comprises at least one wire that extends lengthwise along the axial slots one after another, the wire is angled relative to an axis of the PM machine while extending lengthwise along the stator.

4. The system of claim 1, wherein the second set of windings comprises a wire that extends lengthwise from a first end to a second end of the stator along an interior of the stator, and the wire then extends lengthwise from the second end to the first end along an exterior of the stator, wherein the wire is angled relative to an axis of the PM machine while extending along the interior, the exterior or both.

5. The system of claim 1, wherein the second set of windings is configured to generate a magnetic flux saturating the stator so as to limit fault currents within the PM machine.

6. The system of claim 1, wherein the PM machine comprises a motor.

7. The system of claim 1, wherein the PM machine comprises a generator.

8. The system of claim 1, wherein the PM machine comprises a motor-generator.

9. The system of claim 1, wherein the stator defines a plurality of stator slots, and wherein the second set of windings comprises multiple windings per stator slot.

10. The system of claim 1, wherein the stator defines a plurality of stator slots, and wherein the second set of windings comprise a single winding per stator slot.

11. The system of claim 1, further comprising a main power converter.

12. The system of claim 1, further comprising a main power converter for supplying the PM machine, wherein the second set of windings is powered by the main power converter.

13. The system of claim 1, further comprising a main power converter for supplying the PM machine and a converter, wherein the second set of windings is powered by the converter, which is separate from the main power converter.

14. The system of claim 13, wherein the converter comprises a single-phase H-bridge power converter for exciting the second set of windings.

15. The system of claim 1, wherein the stator is disposed about the rotor.

16. The system of claim 1, wherein the rotor is disposed about the stator in an inside out generator architecture.

17. A permanent magnet (PM) machine comprising:
a stator, comprising:
a first set of windings; and
a second set of windings configured to limit fault currents within the PM machine.

18. The PM machine of claim 17, wherein the second set of windings is wound back and forth toroidally around the circumference of the stator.

19. The PM machine of claim 17 wherein the second set of windings comprises a wire that extends lengthwise from a first end to a second end of the stator along an interior of the stator, and the wire then extends lengthwise from the second end to the first end along an exterior of the stator, wherein the wire is angled relative to an axis of the PM machine while extending along the interior, the exterior or both.

20. The PM machine of claim 17, wherein the second set of windings is configured to generate a magnetic flux saturating the stator so as to limit fault currents within the PM machine.

21. The PM machine of claim 17, wherein the stator defines a plurality of stator slots, and wherein the second set of windings comprises multiple wire threads per stator slot.

22. The PM machine of claim 17, comprising a rotor disposed about the stator in an inside out generator architecture.

23. The PM machine of claim 17, wherein the stator is disposed about a rotor.

24. The PM machine of claim 17, wherein the first set of windings and the second set of windings are powered from the same power source.

25. The PM machine of claim 17, wherein the first set of windings and the second set of windings are powered from different power sources.

26. A method for winding stator coils; comprising:
winding a first set of coils with a stator of a permanent magnet (PM) machine; and
winding a second set of coils back and forth toroidally around the circumference of the stator.

27. The method of claim 26, comprising winding the second set of coils after winding the first set of coils.

28. The method of claim 26, comprising disposing a spacer between the stator and the first set of windings.

29. The method of claim 26, comprising winding the first set of coils after the second set of coils.

30. The method of claim 26, wherein winding the second set of coils comprises routing a wire lengthwise along an interior of the stator in a first slot from a first end to an opposite second end, routing the wire from the interior to the exterior of the stator at the second end, routing the wire lengthwise along the exterior from the second end to the first end, routing the wire into a second slot, and repeating the process for the second slot and each successive slot of the stator.

31. The method of claim 26, comprising extending a wire lengthwise along axial slots one after another such that the wire is angled relative to an axis of the PM machine while extending lengthwise along the stator.

32. The method of claim 26, wherein the second set of windings is configured to generate a magnetic flux saturating the stator so as to limit fault currents within the PM machine.

33. A system for generating supplemental electrical power from a rotating member of a turbofan engine, the system comprising:
a permanent magnet (PM) generator for generating electrical power, the PM generator comprising:
a stator;
a rotor rotatably mounted relative to the stator;
a primary set of windings disposed within the stator;
an auxiliary set of windings wound back and forth toroidally around the circumference of the stator; and
a main power converter for converting the electrical power from the PM generator to power a load,
wherein the rotating member of the turbofan engine is coupled to the rotor of the PM generator for driving the PM generator.

34. The system of claim 33, wherein the auxiliary set of windings is powered by the main power converter.

35. The system of claim 33, further comprising an auxiliary power converter for supplying the auxiliary set of windings.

36. The system of claim 35, wherein the auxiliary converter comprises a single-phase H-bridge power converter for exciting the second set of windings.

37. The system of claim 33, wherein the rotating member comprises a low-pressure (LP) turbine spool.

38. The system of claim 33, wherein the auxiliary set of windings is wound back and forth in a zigzag pattern toroidally around the circumference of the stator.

39. The system of claim 33, wherein the auxiliary set of windings is configured to generate a magnetic flux saturating the stator so as to limit fault currents within the PM generator.

40. The system of claim 33, wherein the turbofan engine is mounted on an aircraft.
